(19) United States
(12) Patent Application Publication
(10) Pub. No.: US 2005/0108202 A1
(43) Pub. Date: May 19, 2005

(54) Information search system and information search method

(76) Inventor: Haruhiro Nishikubo, Saitama (JP)

Correspondence Address: CANTOR COLBURN LLP, 55 Griffin Road South, Bloomfield, CT, 06002, US

(21) Appl. No.: 10/696,613

(22) Filed: Oct. 29, 2003

(51) Int. Cl. G06F 17/30

(52) U.S. Cl. 707/3; 707/10

(57) ABSTRACT

A system according to the present invention comprises: a reception server for receiving an access request from a network; a registration receiving part for searchably registering access information in a database, based on search condition information which includes plural words and an association word for semantically associating the plural words; and a DB managing part for, in reply to a search request based on search condition information, searching for the search condition information registered in the database to output the access information. With this configuration, the present invention allows accurate search for desired information.

### BACKGROUND OF THE INVENTION

1. Field of the Invention

The present invention relates to a search system for providing information search services via a network such as the Internet and a search method therefor, and particularly, to a search system for allowing a search for desired information to be done with high accuracy and a search method therefor.

2. Related Art

When searching for information via Internet, people usually utilize a search system available on a chargeable or free-of-charge basis. Such an Internet search system is classified into a directory-type search system and a robot-type search system.

A directory-type search system is a system for providing search services on the basis of a group of information pieces (directory) registered manually by an editor (person) who reviews websites, web pages and text thereof. A robot-type search system is a system for providing search services on the basis of information pieces which are automatically gathered on a website by circulating throughout the systems on the Internet (websites) by use of a software like a web spider.

Both of the search systems are common in entering gathered information into a database with a link (Internet address) to a location of the information. Some robot-type search engines get information on searched web pages and store the information into databases.

However, in the conventional robot-type search system and directory-type search system, since data corresponding to ORed or ANDed plural words is extracted, there sometimes occurs a problem of difficulty in searching for desired information efficiently, for example, much undesired and miscellaneous information is sometimes collected, or to the contrary, less information is collected because too specific information is used for search. Further in such search systems, if desired information is registered and available on the Internet at a later date, it can be obtained only by searching the Internet again. Furthermore, an information provider can not register presence of his own information in a search system directly online.

### SUMMARY OF THE INVENTION

According to the present invention, with search condition information (title phrase) of fixed phrase pattern prepared by connecting any words by a predetermined association word, access information for access to a system (e.g., home page) which has detailed information about the search condition information is stored in association with the search condition information. Then, search condition information is searched for in response to a search request. As a result of search, access information stored in association with the matched search condition information is output as hit information. Since search condition information is formalized by given association words and used as key information in both registration and search, it is possible to extract desired information only.

An information search system according to a first embodiment of the present invention is an information search system comprising: a reception server which is connected to a network including the Internet to receive an access request form an external system connected to the network; access data storing means for storing searchably in association with search condition information including one or a plurality of words and association information for semantically associating the words with one another, access information expressing a location of information to be searched which is specified by the search condition information; registration processing means, connected to said reception server, for performing registration of the access information into a database under a predetermined condition, based on a registration request received via the network; and searching means, connected to said reception server, for searching the search condition information in the database under a predetermined condition, based on a search request received via the network and outputting a search result which includes the access information corresponding to the search condition information.

An information search system according to another embodiment of the present invention is an information search system in which the access information comprises a link address to a message board or a home page.

An information search system according to yet another embodiment of the present invention is an information search system in which the association information comprises a short association word which indicates relation between the words, including apposition, possessive, belongingness, attribution, purpose or relation.

An information search system according to still yet another embodiment of the present invention is an information search system in which the association word comprises: “of”, “for” and “on”.

An information search system according to another embodiment of the present invention is an information search system in which the association word corresponds to a predetermined association word in another language.

An information search system according to yet another embodiment of the present invention is an information search system in which the above-mentioned searching means carries out search by exact matching of search condition information specified by the search request and the search condition information in the database.

An information search system according to still yet another embodiment of the present invention is an information search system in which the above-mentioned registration processing means comprises information storing means which is accessed based on the access information and the above-mentioned information string means comprises information registering means for registering information to be provided, corresponding to the search condition information.

An information search system according to another embodiment of the present invention is an information search system in which the above-mentioned information storing means comprises a message board.

An information search method according to a first embodiment of the present invention is an information search method comprising the steps of: (a) receiving an access request form an external system connected to a network; (b) in response to a request from the external system, registering in a database: search condition information including one or a plurality of words and predetermined association information for semantically associating the words with one another; and access information for accessing to public information disclosed corresponding to the search condition information so as to allow search with use of the search condition information as search key information; (c) in response to a request from the external system, searching the database based on the search condition information specified by the external system and reading out the access information corresponding to the search condition information; and (d) transmitting the access information read out as a search result to the external system.

An information search method according to another embodiment of the present invention is an information search method in which the above-mentioned step (b) further comprises the step of: (b-1) in response to a request from the external system, registering public information disclosed corresponding to the search condition information in a predetermined disclosing medium.

An information search method according to yet another embodiment of the present invention is an information search method in which the access information registered in the step (b) and the step (b-1) comprises a link address to a home page or a message board.

An information search method according to still yet another embodiment of the present invention is an information search method in which the association information comprises a short association word which indicates relation between the words, including apposition, possessive, belongingness, attribution, purpose or relation.

An information search method according to another embodiment of the present invention is an information search method in which the association word comprises: “of”, “for” and “on”.

An information search method according to yet another embodiment of the present invention is an information search method in which wherein the association word corresponds to a predetermined association word in another language.

An information search method according to still yet another embodiment of the present invention is an information search method in which searching in the step (c) is carried out by exact matching of search condition information specified by the request and the search condition information in the database.

### BRIEF DESCRIPTION OF THE DRAWINGS

FIG. 1 is a view for conceptually illustrating an information search system according to an embodiment of the present invention and its connection state to a network;

FIG. 2 is a functional block diagram of a web server;

FIG. 3 is s functional block diagram of DB managing means of a database system;

FIG. 4 is a functional block diagram of registration receiving means;

FIG. 5 is a flow chart of registration procedure of access information according to an embodiment of the present invention;

FIG. 6 is a view for illustrating search/registration screen (initial screen) transmitted from a web server, or for illustrating an entry state when registering information to be provided;

FIG. 7 is a view for illustrating a screen for designating a link;

FIG. 8 is a view for illustrating a registration screen of access information to a home page;

FIG. 9 is a view for illustrating a screen for registering information to be provided at a message board (contents and comment are already shown);

FIG. 10 is a view for illustrating an entry example to a search/registration screen when registering information on “what is desired”;

FIG. 11 is a view for illustrating a registration screen of “what is desired”;

FIG. 12 is a view for illustrating an entry screen of access information (URL) which expresses a location of “what is desired”;

FIG. 13 is a view for illustrating a screen for entering “what is desired” which is to be put on a message board;

FIG. 14 is a flowchart for showing the procedure of processing of an information search system when receiving a search request;

FIG. 15 is a view for illustrating an entry example to a search/registration screen when searching information;

FIG. 16 is a view for illustrating a screen display of a search result;

FIG. 17 is a view for illustrating a list of a search result of home pages;

FIG. 18 is a view for illustrating a list of a search result of message board;

FIG. 19 is a view for illustrating a display of a message board from a search result;

FIG. 20 is a view for illustrating a list of a branch message board;

FIG. 21 is a view for illustrating an example of a branch message board;

FIG. 22 is a view for conceptually illustrating an information search system according to a second embodiment of the present invention and its connection state to a network; and

FIG. 23 is a view for conceptually illustrating an information search system according to a third embodiment of the present invention and its connection state to a network.

### DETAILED DESCRIPTION OF THE INVENTION

With reference to the drawings, embodiments of the present invention will be described below. The present invention was carried out in view of the above-mentioned problems of the related art. It is an object of the present invention to provide an information search system and an information search method for searching noiseless desired information as accurately as possible based on search condition information (title phrase) prepared by specifying desired information precisely by fixed phrase pattern.

Another object of the present invention is to provide an information search system and an information search method in which an information provider or a person who searches information is allowed to register access information (link information) to “information to be provided” or “information to be searched for”.

Yet another object of the present invention is to provide an information search system and an information search method in which an information provider or a person who searches for information is allowed to register “information to be provided” or “information to be searched for” to a message board or other information disclosure means that is managed by the information search system.

Still yet another object of the present invention is to provide an information search system and an information search method for automatically distributing the latest searched information to a person who has registered desired information in association with search condition information (title phrase) of predetermined fixed phrase pattern.

An information search system according to an embodiment of the present invention comprises: a reception server, connected to a network such as the Internet, for receiving an access request from the network; a database for storing access information which expresses a location of information to be searched specified by search condition information of fixed phrase pattern including one or a plurality of words and association information for semantically associating the words with one another, in association with the search condition information; registration processing means, connected to the reception server, for performing registration of the above-mentioned access information into the above-mentioned database under a predetermined condition based on a registration request via the network; and searching means, connected to the reception server, for searching the database for search condition information under a predetermined condition based on a search request via the network to output search result information including access information corresponding to the search condition information.

In other words, this information search system allows an information provider to register access information for accessing his own information, which is to be put on a home page or a message board, in a database of the information search system in such a manner that the access information is searchable by search condition information of title phrase. Accordingly, the access information can be searched for in accordance with search condition information by a third party.

Of importance is that search condition information is composed of a formalized phrase including one or plural words and predetermined association information for semantically associating the words with each other. Since registration and search are carried out both in accordance with such search condition information of predetermined fixed phrase, only desired information can be accurately obtained as a search result.

Here, attention should be paid to the fact that “information to be provided” and “information to be searched for” each have information on “what is provided” and information on “what is desired”.

In other words, the “information to be provided” (registered information) includes information on “what is provided” and information on “what is desired”, both of which information can be registered in the information search system. For example, for a person who provides in-field cleaning services, the “in-field cleaning service” is “what is provided” while for a person who seeks an in-field cleaning service, the “in-field cleaning service” is “what is desired”. When it is difficult to find desired information, “what is desired” itself can be registered.

In the other hand, the “information to be searched for” (searched information) includes information on “what is provided” and information on “what is desired”. Since “information to be searched for” for a person who provides in-field cleaning services as mentioned above is “registered information” of a person who seeks such services, he searches for information on “what is desired”, while a person who seeks an in-field cleaning service, he searches for “what is provided”.

An information search system according to another embodiment of the present invention not only receives registration requests of access information, but also provides provided-information storing means, which is accessed based on the access information, with provided-information registering means for registering provided information corresponding to search condition information. That is, an information provider not only registers accessing means such as URL of his own home page in a database of the information search system, but also can register or put the provided information on a predetermined message board specified by the information search system. In this way, since an information provider is permitted to register access information and information open to the public, there is an increased possibility that a search database becomes increased self-multiplicatively to be a useful or valuable database.

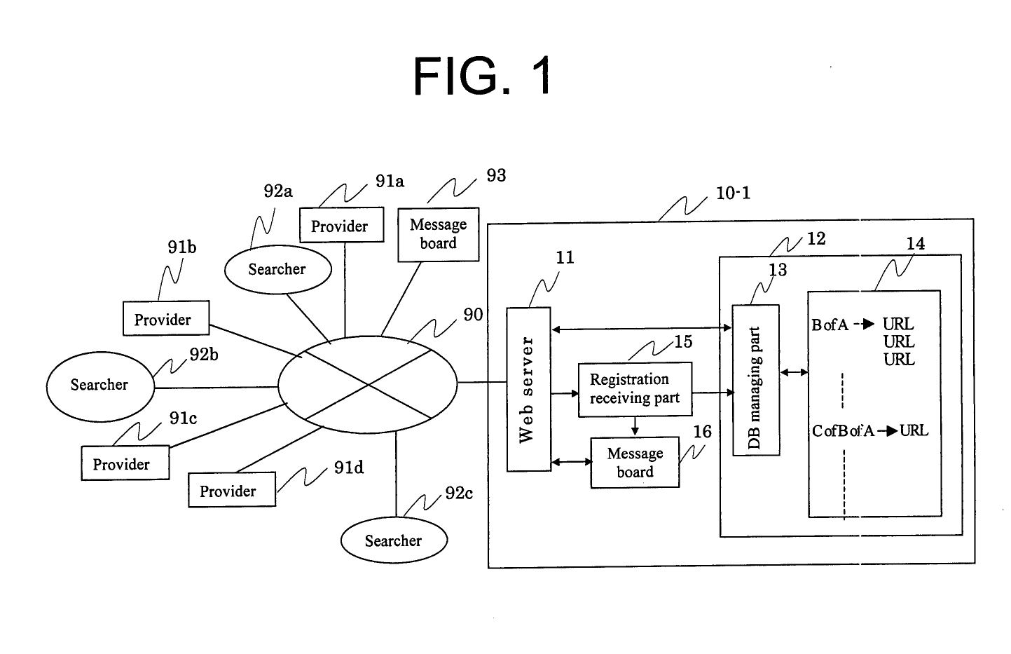

FIG. 1 conceptually shows an information search system according to an embodiment of the present invention and its connection state to a network. An information search system 10 according to first and second embodiments of the present invention is connected to many systems via a network 90 such as the Internet. In FIG. 1, provided as different access units to the information search system 10 are information providers 91 and information searchers 92 which are both connected to the network 90. Here, the information providers 91 mean systems each of which is provided with a home page or a message board for placing predetermined information open to the public. Regarding an information searcher, although it usually means a person who searches information, however in the present invention, the information searchers 92 mean systems each operated by a searcher. In addition, since a message board 93 is connected to the network 90, an information provider can post information not only to his own home page or message board managed by himself, but also to a message board 93 managed by another person.

(System Configuration)

The information search system 10 is configured to include a web server 11 (reception server); a database system 12, a registration receiving part 15; and a message board 16. In this embodiment, the message board 16 is provided within the search system 10 for the sake of simple explanation. However, the message board 16 may be provided not inside the search system 10 but connected to the search system 10 via LAN or to the network 90 like the message board 93. The web server 11 is a server connected to other systems 91 and 92 via the network 90 for data reception/transmission. The web server 11 transmits a web page in response to a request and makes processing such as accessing to the database system via a CGI or the like.

The database 12 includes a DB managing part 13 and a database for storing search information. The database 14 constitutes a storage for storing a large amount of data such as a disc device, and stores access information (link information or the like) to a system connected on the Internet which holds information (data) corresponding to search condition in association with the search condition information. In the database system of the present invention, the search condition information is of a formalized phrase including word information and predetermined association information for associating meanings of the word information. For example, in a database 14 shown in FIG. 1, word information is indicated by A, B and C while association information is “of”. Positioning of the word information and the association information is also an important factor of the search condition. The DB managing part 13 searches across the database 14 based on search condition information from the web server 11 or the like, and when there exists corresponding access information, the DB managing part 13 reads out the access information to output it to the web server 11.

When there is a registration request from any of the information providers 91a to 91d to the web server 11 via the network 90, the registration receiving part 15 receives the request from the web server 11 and registers access information (link information) of the system in association with the information search condition in the database 14 of the database system 12. In addition, it registers information to be put public on a message board 16 in reply to a registration request to a message board.

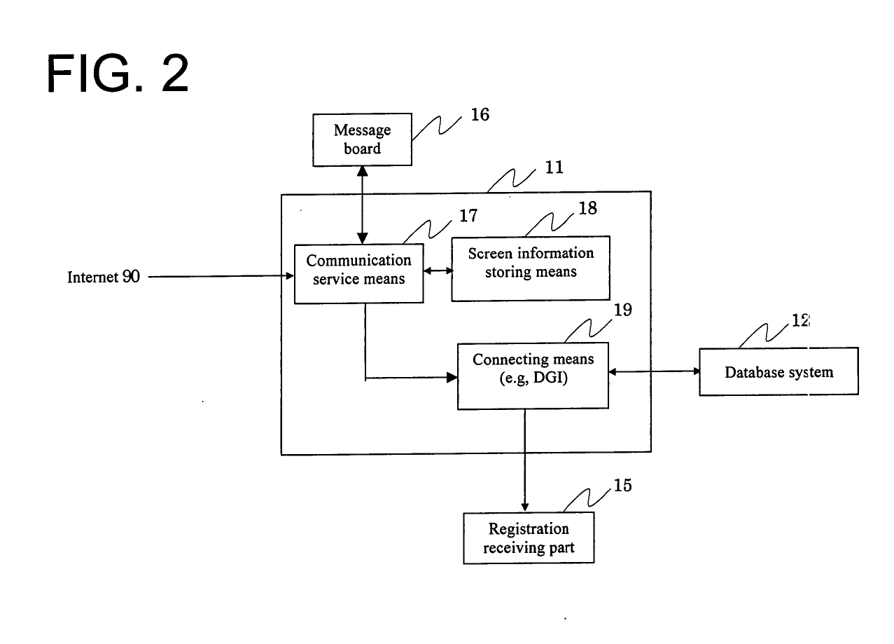

Here, in FIG. 1, the web server 11 functions as a reception server of the present invention, the DB managing part 13 as searching means, and the database 14 as access information storing means. The registration receiving part 15 and the DB managing part 13 are cooperated to serve as registration processing means. Hereinafter, the web server 11, the database system 12 and the registration receiving part 15 will be described more in detail with reference to FIG. 2 to FIG. 4.

(Web Server 11)

FIG. 2 is a functional block diagram of a web server 11. The web server 11 includes communication service means 17, screen image storing means 18 and connecting means 19. The communication service mean 17 performs communication between systems via a network 90 based on a predetermined communication protocol. For example, an access request from a given browser is received in the Internet, and in response to the request, information put on a home page or message board is read out of the screen image storing means 18 or the message board 16 to be transmitted to a requesting system. The screen image storing means 18 stores web pages of home pages or the like. The connecting means 19 is means for performing database search or other processing via a web server such as a common gate interface (CGI). An information provider who accesses a home page clicks on a search request option on the home page and gets access to a database 12 from the communication service means 17 via the connecting means 19. In addition, registration receiving processing, which is described later, is carried out by use of connection via the connecting means 19 to the registration receiving means 15.

(Database System 12)

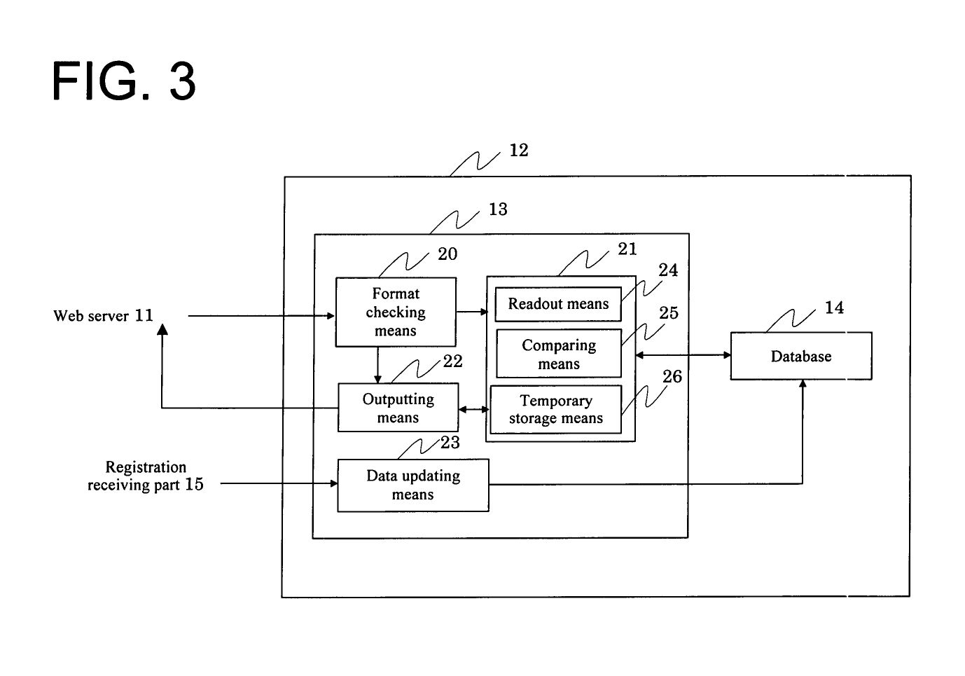

FIG. 3 shows a block diagram of a DB managing means 13 of a database system 12. The DB managing means 13 comprises format checking means 20, search processing means 21, outputting means 22, data updating means 23 and a database 14. The format checking means 20 is means for checking whether search condition information is proper or not, the search processing means 21 is means for performing information search, the data updating means 23 is means for performing data updating, for example, rewriting, deleting and adding of data in the database 14. When the database system 12 receives a search request via the connecting means 19 of the web server 11, the format checking means 20 checks correctness of a format of search condition information of the received search request. If the format of the search condition information is not correct, the outputting means 22 is used to output a message stating that the format is not correct. If the format is correct, the search processing means 21 performs search processing, and the outputting means 22 outputs a search result.

The search processing means 21 comprises readout means 24, comparing means 25 and temporary storage means 26. The readout means 24 reads out search condition information stored in the database, and the comparing means 25 compares the readout search condition information with requested search condition information. When both of the search condition information pieces are matched, access information stored corresponding thereto is read out to be stored temporarily in the temporary storage means 26 and output to the outputting means 22. The outputting means 22 outputs data from the format checking means 20 and the search processing means 21 to the web server 11. The data updating means 23 performs control so as to add, modify or delete contents of the database 14 corresponding to input data.

(Registration Receiving Means 15)

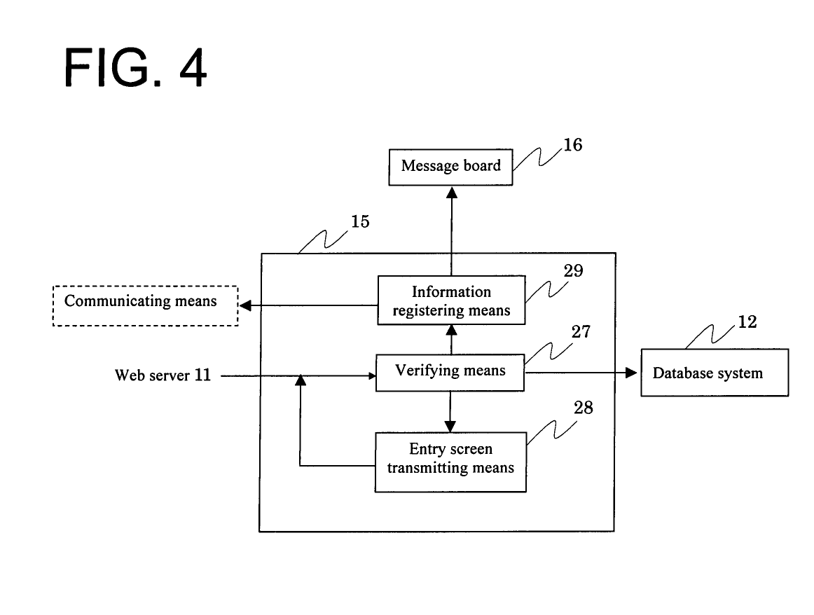

FIG. 4 shows a functional block diagram of registration receiving means 15, which comprises verifying means 27 and entry screen transmitting means 28. The verifying means 27 authenticates a person who requests registration of information and verifies input information. As a rule, the verifying means performs authentication of a person who requests registration, and accepts his request only when he is authenticated. Or, the verifying means may be set open so as to receive a registration request from any person. With this configuration (open registration), information registering means 29 may be preferably set to check registration requirements strictly.

When registration is permitted, the entry screen transmitting means 28 transmits an entry screen for receiving an entry of information for registration to a system 91 of a registrant. Specific description about the screen to be transmitted will be made later. Data entered in accordance with the entry screen is then input to the verifying means 27, which verifies matching of format of the data to a predetermined format for registration. When the format of the data is not proper (not verified), registration is refused. Here, first step is verifying a format of search condition information. When the format is not verified, a comment for modifying the format of the search condition information is output or registration is refused. Further, it may be configured to verify access information corresponding to search condition information. In such a configuration, verification of access information may be carried out not only by checking a format thereof but also by accessing information based on the access information. Furthermore, it may be checked by keyword check whether there exists information at a location corresponding to access information. When a format of the entered information is matched to a predetermined format, the entered information is output to the database system 12 and at the same time, the database system is instructed to carry out predetermined registration. Besides, when information provided to the public is put on a message board, the information registering means 29 is used to register the information entered to the message board 16.

(Registration Procedure of Access Information and Public Information)

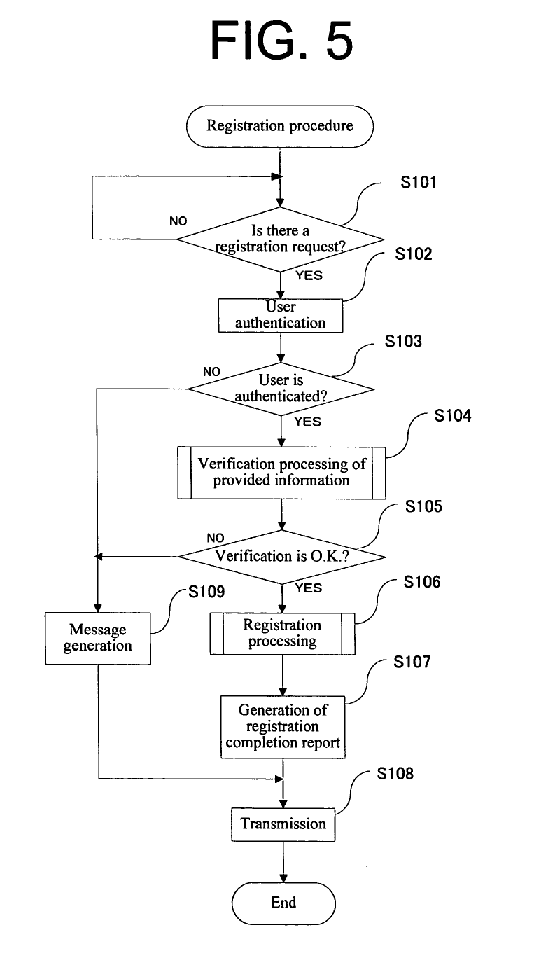

First description is made about registration of access information by an information provider 91. FIG. 5 shows a flowchart of the procedure for registering access information according to an embodiment of the present invention. When there is an access to a web server 11 via a network 90, the web server 11 reads out initial screen information from screen information storing means 18 and transmits a search/registration screen. When the information provider 91 requests information registration on the search/registration screen, such a request is transmitted to the system. When the request for information registration is received from the information provider 91 (S101; YES), verifying means 27 performs user authentication (S102). When a result of user authentication shows that a user is not authenticated (S103; NO), a message stating that a user is not authenticated is generated and transmitted (S109, S108). For open registration, user authentication is not performed.

When a result of user authentication shows that a user is authenticated (S103; YES), the procedure goes to the next step of performing verification of information to be registered and other entered information. In this step, various kinds of information is received and verified (S104). For example, it is determined whether search condition information as a search key of access information is comprised of a proper fixed phrase. When a predetermined entry such as search condition information is not made properly or entered information is insufficient (S105; NO), a message stating such a situation is transmitted (S109). When entered information such as search condition information is proper (S105; YES), the registration processing of access information is carried out (S106). In the registration processing, access information is registered in a database 14 with search condition information as a key data so that search can be performed by the search condition information. The access information is link information to information to be provided. For registration onto a message board, information registering means 29 is used to put information on the message board 16. When the registration procedure of access information or public information is completed, a message for reporting completion of registration is produced to be transmitted to a person who has requested registration (information provider) (S107, S108).

(Explanation of Registration Procedure by use of Sample Screen)

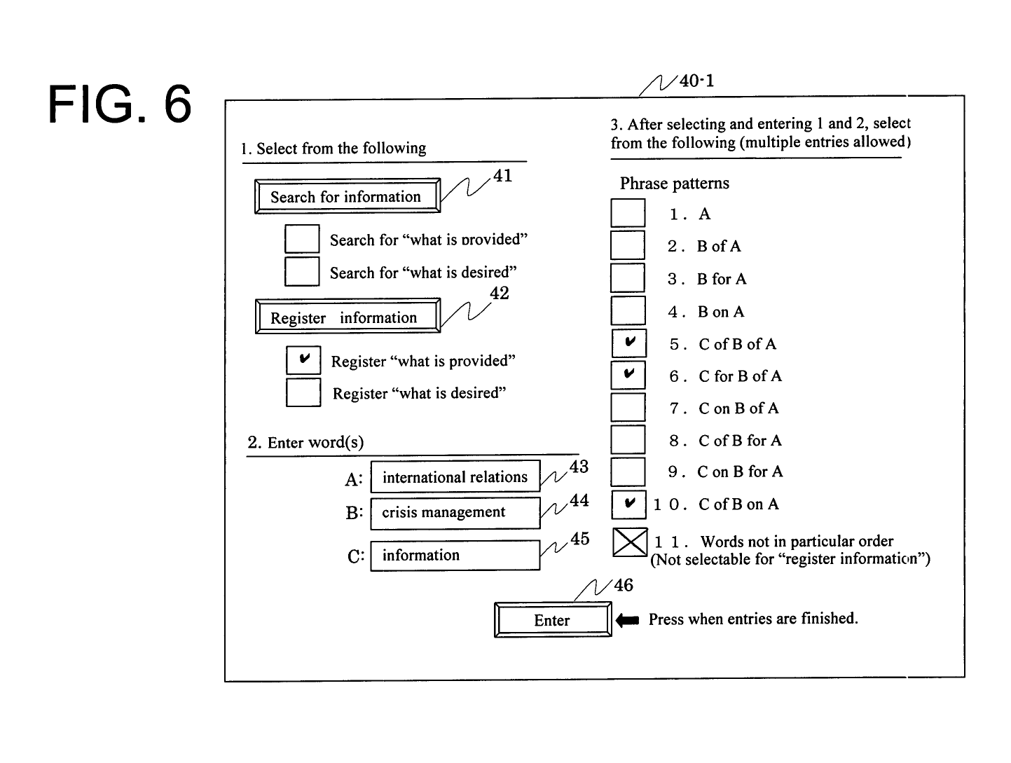

Next description is made about a specific example of the registration procedure, following a screen display. FIG. 6 specifically shows a specific example of a search/registration screen (initial screen) transmitted from a web server 11. In the search/registration screen 40-1, there are first to third input sections and in the first section, selection can be made between “search for information” 41 and “register information” 42.

Selecting the “search for information” in the first section means finding information a searcher wants from already registered information on “what is provided” or “what is desired”. The “register information” is to register a location (access information) of information about “what is provided” or “what is desired” in a search processing system 10 according to the present invention. The section of “search for information” 41 includes search for information on “what is provided” and search for information on “what is desired”. Information on “what is provided” and “what is desired” includes people, material goods, money, technique, knowledge, data and the like. These are searched for so as to know locations of their various public information, and to allow access to their information sources.

Now, suppose that “register information on what is provided” is selected.

The second section is of entering “a word” which constitutes information for obtaining a location of “search for information” or “register information”. In the example on FIG. 6, three words of A to C can be entered, however, it is possible to increase or decrease the number of words to be entered. Here, entered as words corresponding to A to C are “international relations”, “crisis management” and “information”, respectively. Description below is made on the condition that these words are selected.

The third section is of checking for confirmation of phrase patterns of information to be searched for or registered. In order to confirm phrase patterns, extremely simple “association words” are determined in advance for defining relations between information words. These association words in the third section are preferably less enough to define relations between information words. For example, in FIG. 6, used as association words are only three words of “of”, “for” and “on”, any of which is used to connect information words thereby to compose a fixed phrase pattern. Such association words may be used plural times. These words are cited simply as an example, and association words to be used may be freely determined. However, like in the example of FIG. 6, association words are preferably less in number and selected from words which are as short as possible but are capable of defining relations between information words clearly. In order not to complicate the system, it is preferable to determine in advance what association words are used and in which order they are used. The phrase pattern 11. “Words not in particular order” includes phrases which are of patterns selected in the third section and are composed of the words which are those entered in the second section but are aligned in the different order.

When necessary options are all selected and inputted, an entry button 46 is pressed. By pressing this button, the selected and input data are transmitted to a search processing system 10. When a web server 11 receives search information (S101; YES), user authentication as described above is performed (S102). When the user authentication is finished, then, verification processing of information to be registered is performed (S104). In the verification processing, the first step is verifying correctness of a fixed phrase pattern and word inputting of search condition information. In this example, since fixed phrase patterns are determined in the search/registration screen, there occurs no error or problem in the phrase patterns. Then, it is confirmed whether word inputting is appropriate or not, or whether necessary options are all filled in or not. Next, predetermined entry screens required for registration are sequentially transmitted, and inputting is required correspondingly.

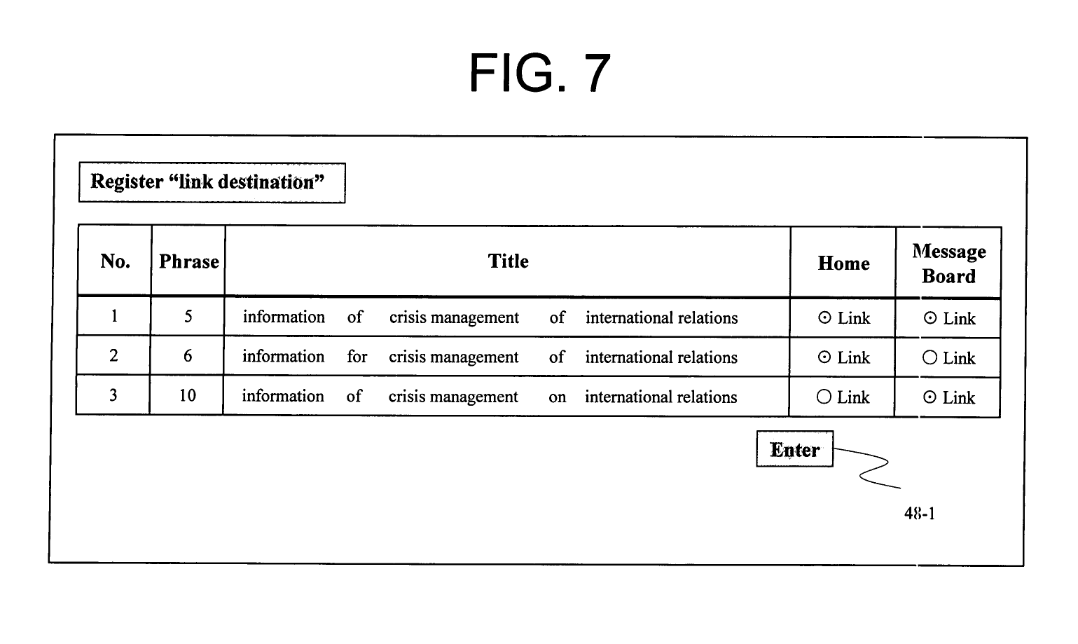

Firstly, a screen for designating a type of link destination to be registered as access information is transmitted. FIG. 7 shows a specific example of a screen for designating a link destination. In the screen on FIG. 7 it can be selected, to link each of the three fixed phrase patterns composed of words designated at the search/registration screen on FIG. 6 to one's own home page or to link them to a message board managed by the information search system. Further, shown in the phrase pattern 5 of FIG. 7, it is possible to link them to both of the home page and the message board. When “Link” in the section of “Home” or “Message Board” is clicked, mark is input in the “Link” so as to designate a link destination. In FIG. 7, a dot is added in the center of each of the designated items. When an “Enter” key 48-1 is pressed down in the state shown on FIG. 7, the information of the designated items is transmitted to the information search system. In the information search system 10, entry screen transmitting means 28 transmits a registration screen to home pages and a registration screen to message boards based on the received information.

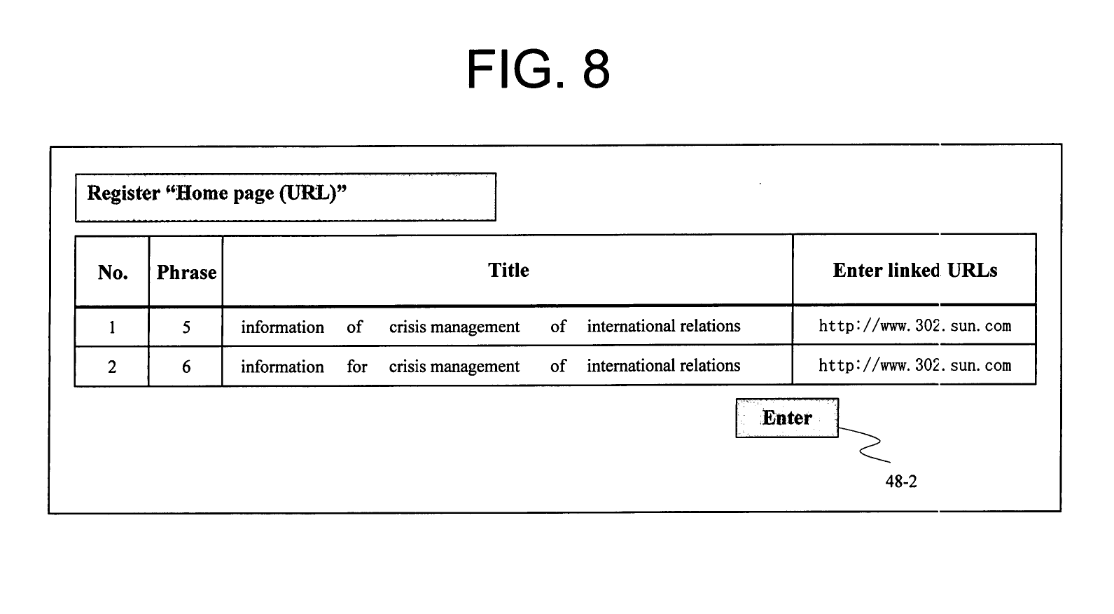

FIG. 8 shows registration screen of access information to home pages. When a registrant enters in each section of link destination on FIG. 8 a URL for linking to public information to be provided and presses an “Enter” key 48-2, the information of the entered URL is transmitted to the information search system. A registration receiving part 15 of the information search system 10 transmits this information to the database system 12. A DB managing part 13 of the database system 12 registers access information (URL) in a database 14 with a title phrase set as search condition information. Likewise, when registering access information of message boards, access information such as URL of message boards and respective message board numbers are registered.

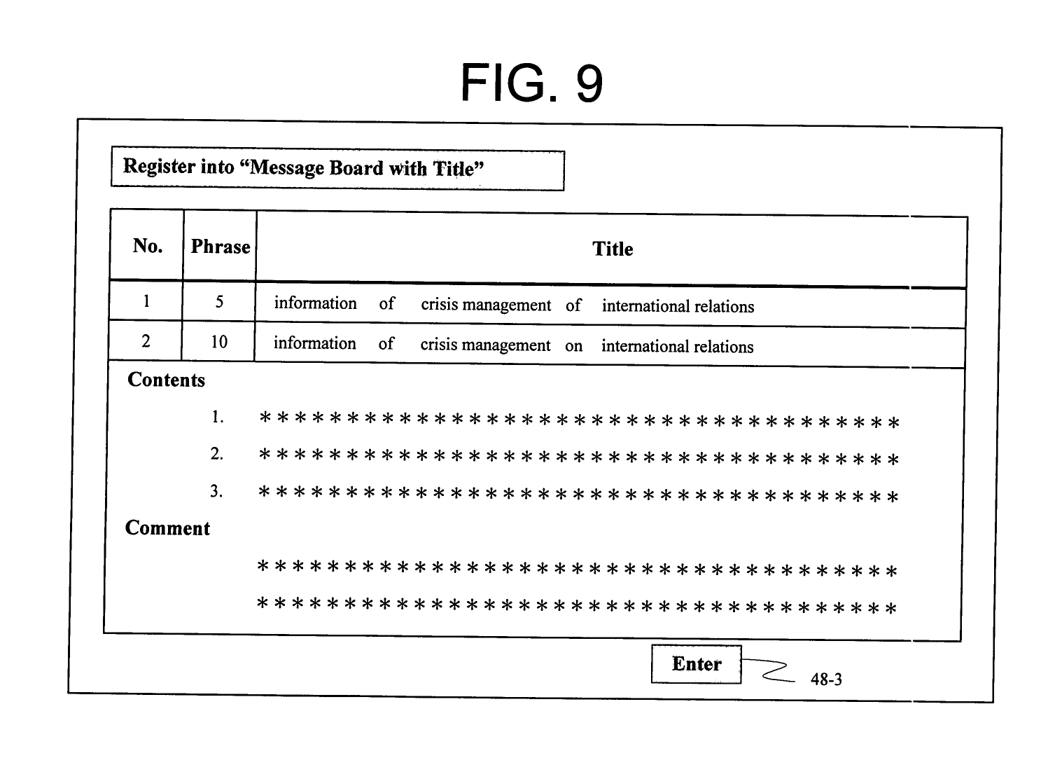

As described above, according to another embodiment of the present invention, it is possible to register information which is to be provided to a message board 16. In this case, a screen for registration to a message board linked from the entry screen of the registration receiving part 15 is transmitted to a registrant system. A screen example for registering information to be provided onto a message board is shown in FIG. 9 (“contents and comment” are already entered). Since message board registration is selected for the phrase patterns 5 and 10 in the screen example of FIG. 7, the screen example of FIG. 9 shows that the same “Contents and Comment” for the two phrase patterns are registered to a message board as information to be provided. When an information provider enters predetermined information in a section of “Contents and Comment” and pushes down an Enter key 48-3, the registration receiving part 15 of the information search system 10 registers the information to the message board 16. Once the information is registered to the message board 16, its access information is transmitted from the information receiving part 15 to the database system 12 to be registered onto the database 14.

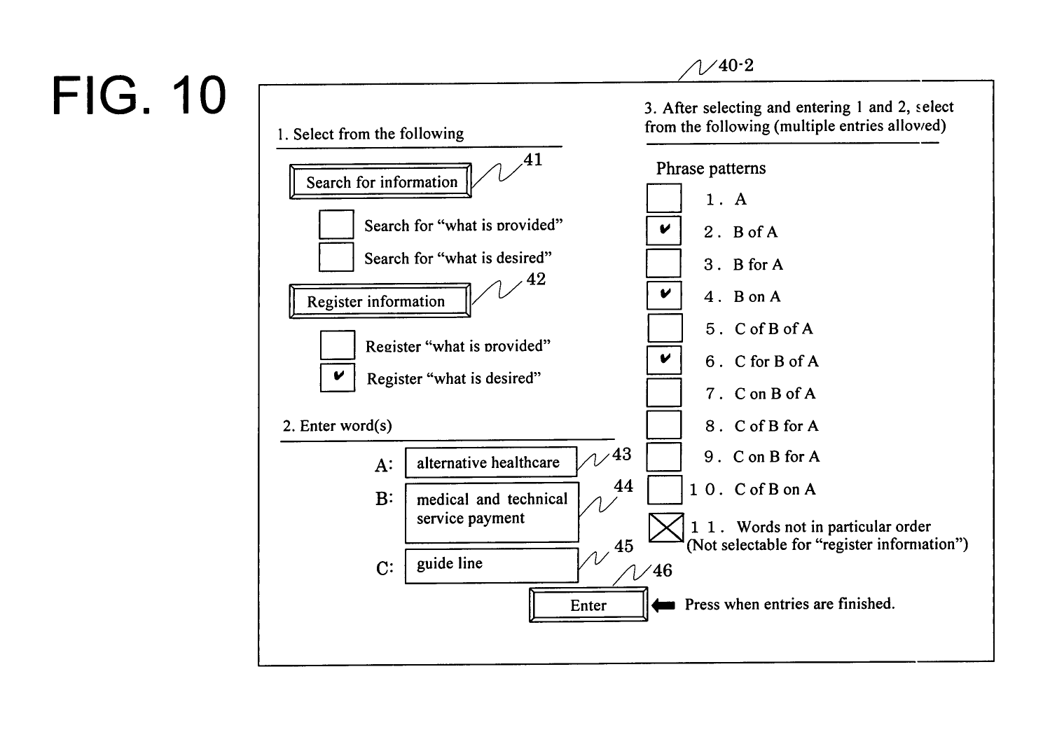

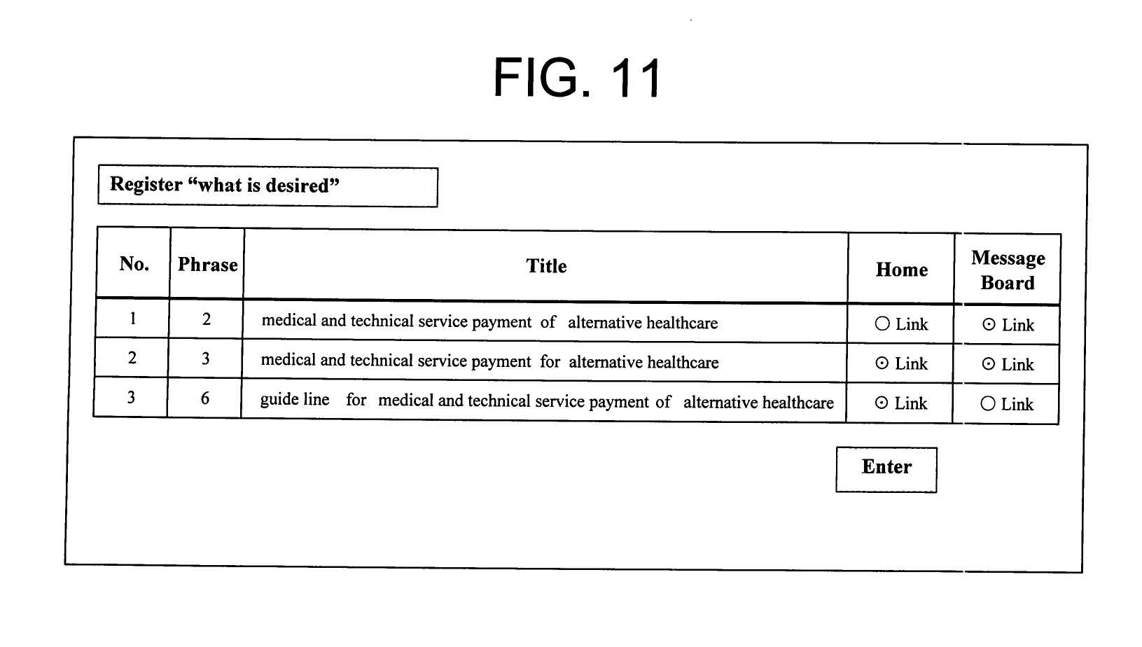

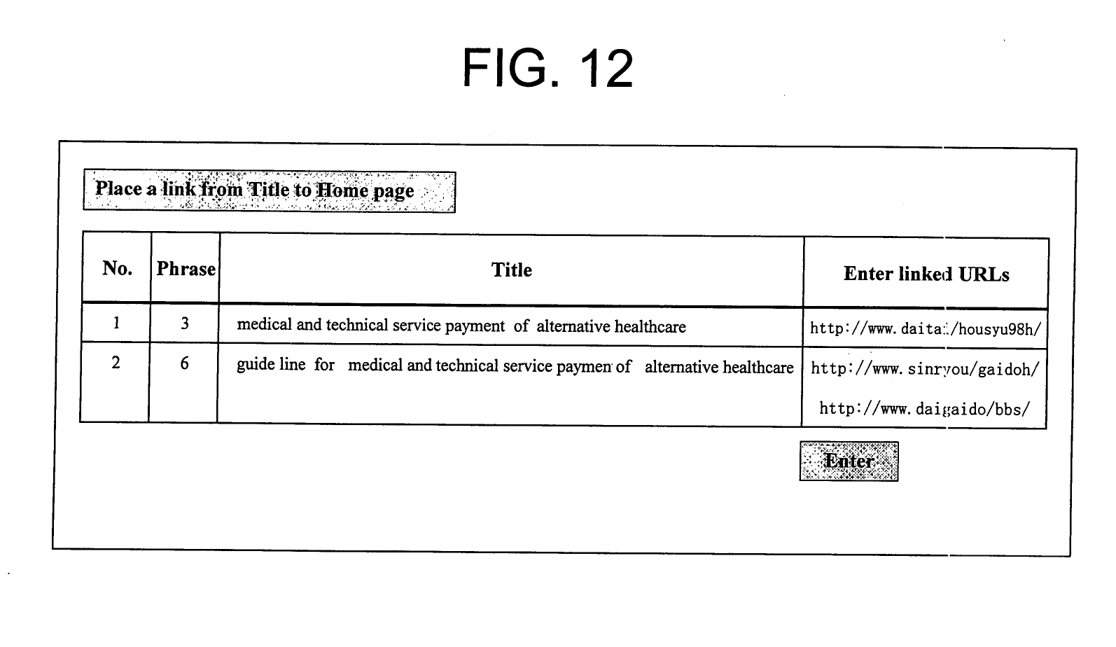

Then, explanation is made about registration of information on “what is desired”, of which an example 40-2 to “search/registration screen” is shown in FIG. 10. In this screen, word(s) or phrase “alternative healthcare”, “medical and technical service payment” and “guide line” are entered and phrase patterns 2, 3 and 6 are designated. In this situation, entry screen transmitting means 28 transmits a registration screen about “what is desired” shown FIG. 11 to a system of a registrant. Since, like in FIG. 7, search condition information including fixed phrase patterns are displayed in the section of “title” of the screen, a location of information for each piece of the search condition information is designated by clicking either “home” or “message board” or both of them. Then, an Enter key is pressed, the entered information is transmitted to the information search system 10. In this way, an entry screen shown in FIG. 12 is transmitted from the information search system. In this screen display, access information (URL) which expresses a location of content corresponding to a title (search condition) of “what is desired” is input, the Enter key is pushed down and then, registration of access information is completed.

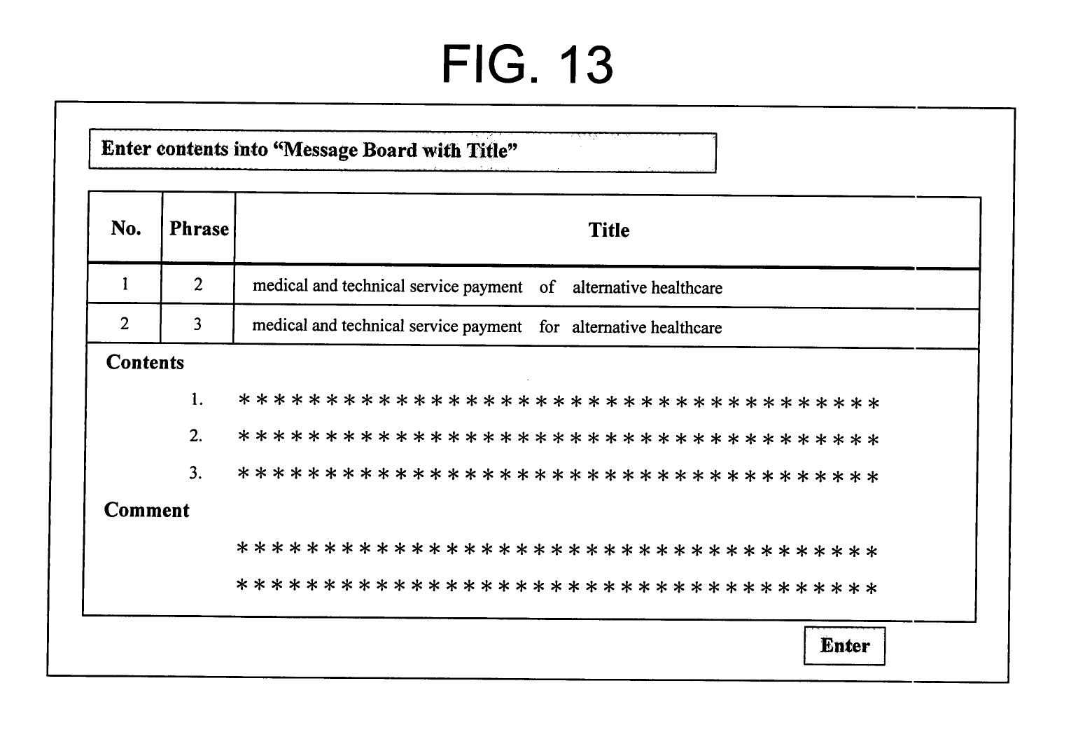

When contents (information) corresponding to a title (search condition information) of “what is desired” are registered, a screen for entering “contents and comment” is transmitted. FIG. 13 is a screen example doe entering information on “what is desired” to be posted to a message board 16 of FIG. 1. Once contents (information or comment) regarding “what is desired” are entered into this screen view and transmitted to the information search system 10, the information is registered to the message board 16. After registration, access information to the message board is registered in the database system 12 together with the search condition information. This registration processing is performed in the same way as that for information on “what is provided”.

(Search Processing Procedure)

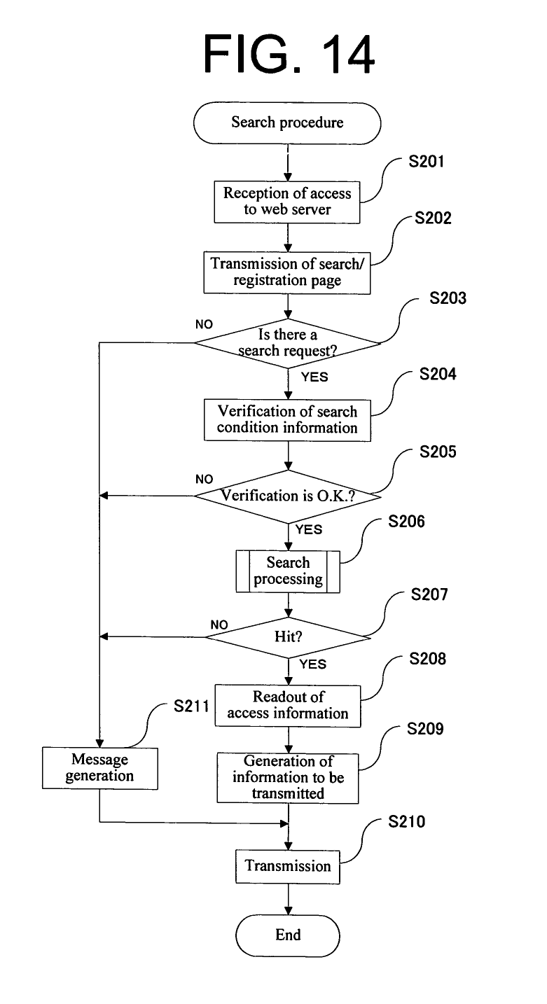

Next description is made about the search processing procedure of search condition information. FIG. 14 is a flowchart for showing the procedure of processing of an information search system when receiving a search request from a searcher. When there is an access from a searcher 92 via a network 92, a web server 11 receives the access (S201), read out a search/registration page from screen information storing means 18 and transmits the page to the searcher 92 (S202).

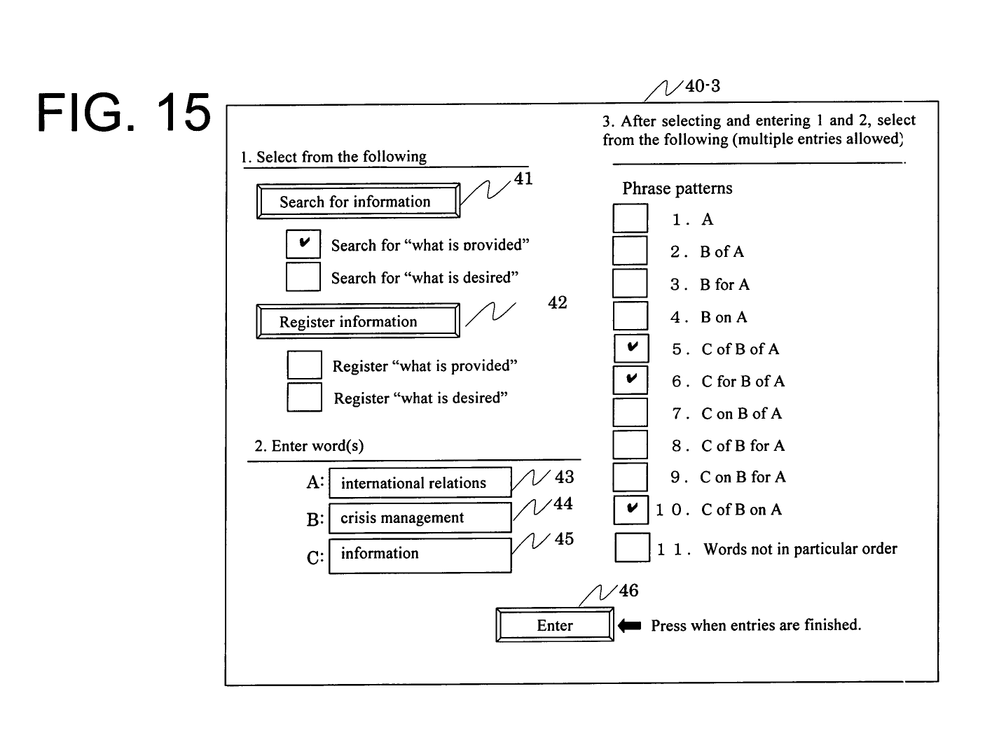

FIG. 15 illustrates a search/registration screen 40-3 which is transmitted to a searcher 92. As shown in FIG. 15, “search for what is provided” is selected at “search for information” 41 of the first section. Entered at the second and third sections are the same things as those in the search/registration screen 40-1 in FIG. 6 (word A “international relations”, B “crisis management”, C “information”, checked phrase patterns: 5, 6 and 10).

When all the necessary options are selected and entered and an Enter button 46 is clicked, information of the selected options is transmitted to an information search system 10. When a web server 11 receives information to be searched (search condition information) (S203: YES), search processing is performed in the information search system 10. When the information is not received by the web server 11 for a predetermine time (S203; NO), the system transmits a message (S211, S210) and otherwise, the search processing is terminated.

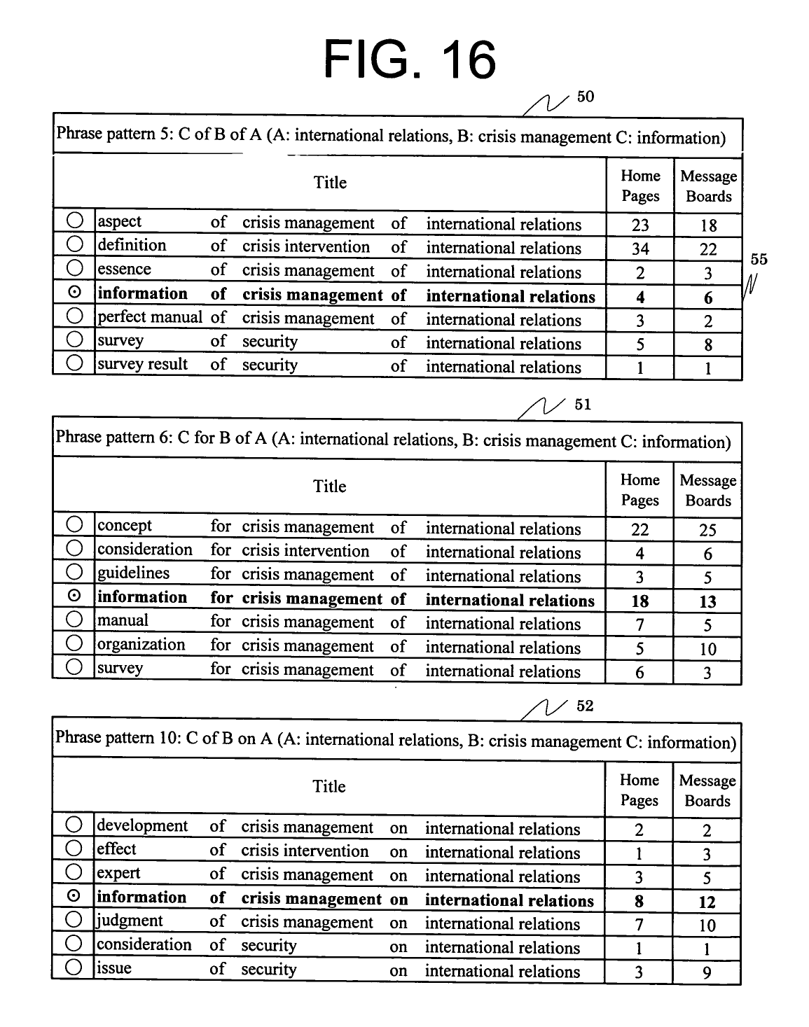

FIG. 16 illustrates a screen display of a search result. Following description is made about each option of the screen displays 50, 51 and 52. The screen display 50 is an example for displaying hit information of a phrase pattern 5, the screen display 51 for displaying hit information of a sentence patter 6, and the screen display 52 for displaying hit information of a sentence patter 10. In these examples, hit information is displayed in bold type at the center of the screen. Displayed prior to and subsequent to the hit information are phrases of different titles. Each title phrase is displayed together with a location(s) (i.e., home page and/or message board) of corresponding information where the information is made open to the public and the number of information locations. With this configuration, a searcher can get to know the number of information hit by search and the number of related information pieces. This data of the numbers of information pieces is generated by the information search system 10, transmitted to a searcher system 92 and displayed on a screen of the display. For example, as shown in FIG. 16, the number of home pages is indicated by “HP 4” and the number of message boards is indicated by “message boards 6” regarding the title “information of crisis management of international relations” 55 on the screen 50 of the phrase pattern 5. As is clear from this, there are four home pages and six message boards corresponding to the title (search information). Also shown in FIG. 16, search of different phrase patterns results in different kinds of information displayed prior to and subsequent to the hit information.

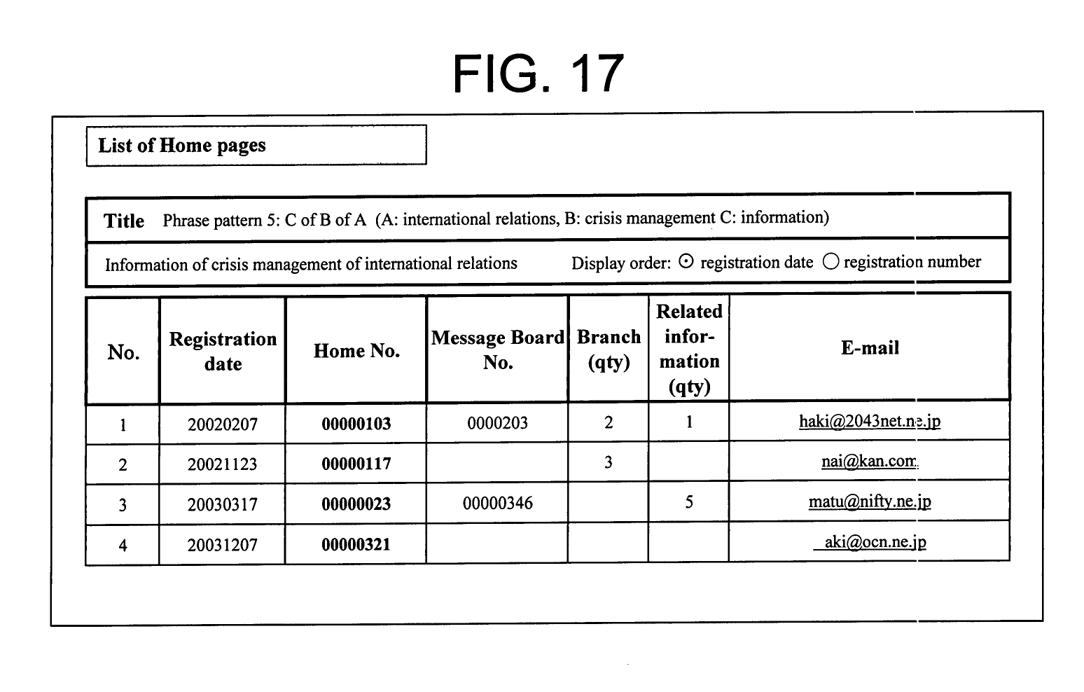

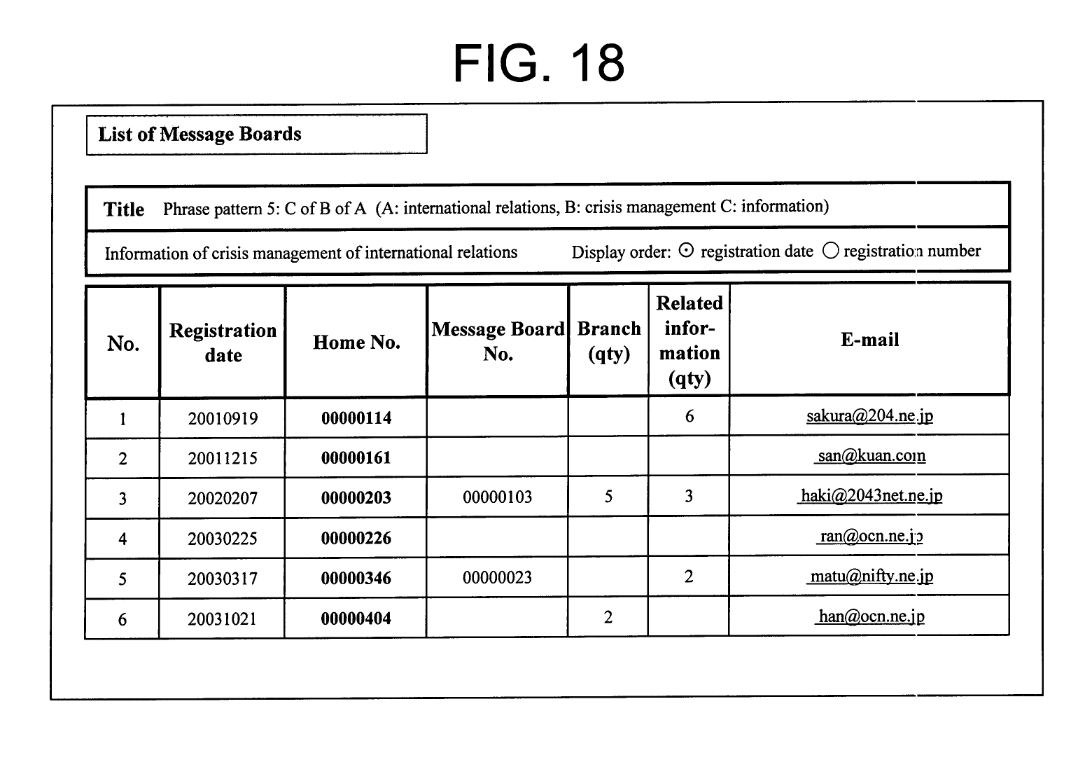

Among the numbers of home pages and the numbers of message boards displayed on the screen, a searcher selects one that he wants to see and clicks it, which is then transmitted to the information search system. When the number of home pages or the number of message boards of the title 55 on the screen of the phrase pattern 50 is selected and clicked, information corresponding to the clicked number is transmitted to the information search system 10. The information search system 10 generates corresponding screen information based on the received information and transmits it to the searcher. FIG. 17 shows a screen example displayed when clicking “HP 4” of the title 55 (list of four home pages). FIG. 18 shows a screen example displayed when clicking “Message Board 6” of the title 55 (list of six message boards).

In the screen of FIG. 17, “title”, “phrase pattern” and selecting part of the display order appear at the upper side, and hit information numbers, registration dates, home page numbers (Home NO), message board numbers (Message Board NO), the number of branches (Branch (dty)), the number of related information pieces (Related information (qty)) and E-mail addresses appear in the center, in the ascending order of the registration dates. The home numbers and message board numbers are numbers attributed by the system. When clicking them, the screen is allowed to be linked to corresponding display pages. For a row in which both of home number and bulletin number are shown, it is meant that the same contents are placed on the home page and the message board. In this case, click on the Home NO or the Message Board NO provide link to a corresponding home page or message board. However, with click on no matter which NO, information of the same contents can be viewed.

Regarding the section of the numbers of branches, this number shows the number of low-level registered home pages or message boards (child home pages or child message boards) provided in association with respective cases (parent home pages or parent message boards). Regarding the section of “related information”, information linked therefrom is not information directly obtained by the same title but just information related thereto.

FIG. 18 is a screen example of a message board. What is displayed on the screen is similar to that for a home page in FIG. 17, however is different in that information on the message board is centered in FIG. 18. In the list of FIG. 17, the Home NOs “00000103” and “00000023” which appear with corresponding Message Board NOs are also shown in FIG. 18. Since there are six pieces of information corresponding to the search condition information (title phrase) in FIG. 18, six message boards are listed.

When a searcher clicks on a desired one among Home NOs and Message board NOs displayed in FIGS. 17 and 18, the page is linked to a home page or message board of the clicked NO and corresponding information is displayed on a system of the searcher.

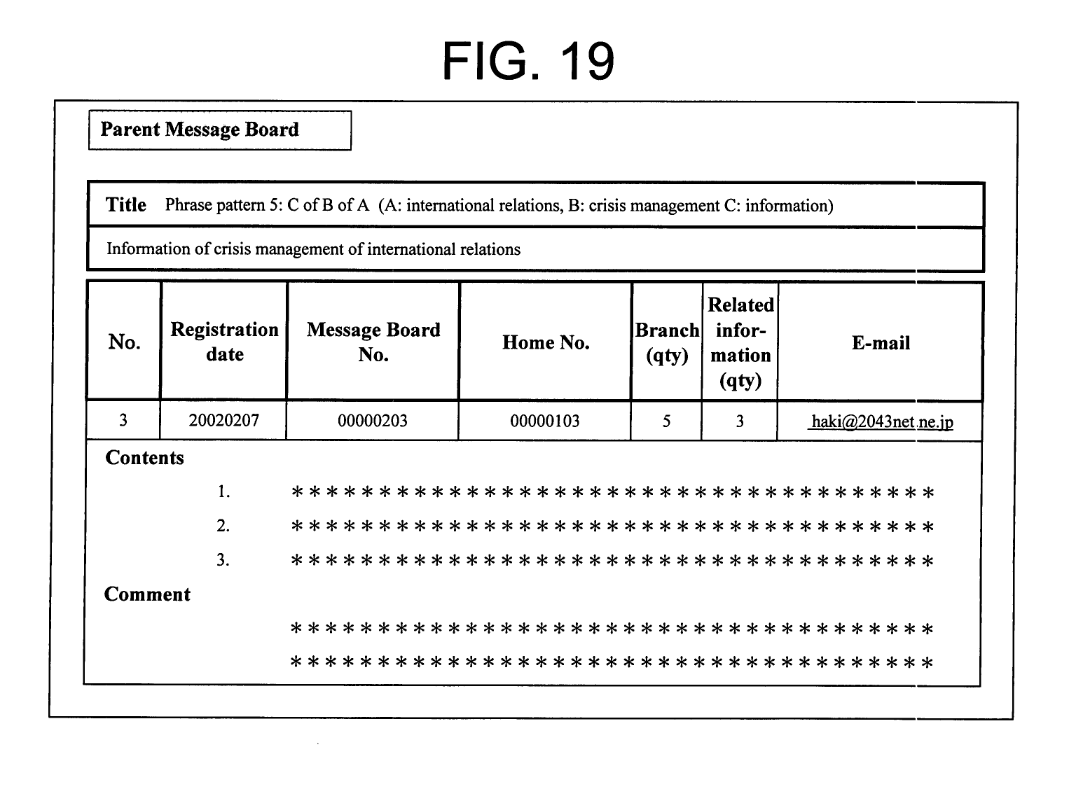

FIG. 19 shows a screen example which is read out by clicking the Message board NO: 00000203 of FIG. 17 and displayed on the system of a searcher. This screen frame shows a parent message board, and title phrase, phrase pattern display and word or phrase information appear at the upper side, and bibliographic information including registration dates, message board numbers (Message Board NO), the number of branches appears at the upper side in the center table. Shown at the lower side of the table is main information (contents and comment) provided by the message board. This information is such as desired by the searcher.

The message board shown in FIG. 19 is a parent message board, and as is seen from the bibliographic information, there are five branches. In other words, there are five pieces of low-level information (child message boards) which correspond to the same title phrase. When a searcher wishes to browse message boards of low level, he clicks on the section of “Branch (qty)” in FIG. 19. Then, corresponding information is transmitted to the information search system 10. The information search system 10 reads out a list of the message boards (branches) for disclosing low-level information and transmits it to a searcher system 92 as screen data.

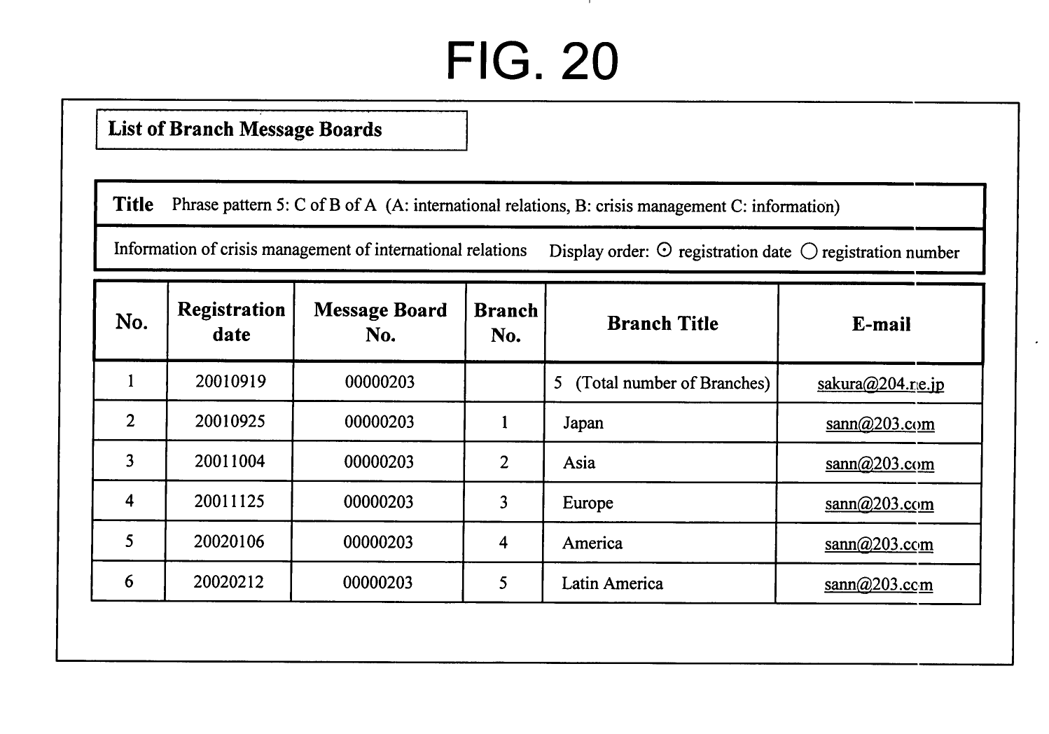

A screen example displayed in this situation is illustrated in FIG. 20. The first piece of information in a display list in FIG. 20 shows “parent message board” as described above with reference to FIG. 19. The second to sixth pieces of information correspond to the list of low-level message boards. As seen from this list, the branch titles of low-level information are information of countries or areas corresponding to the title phrase “information of crisis management of international relations”. Since such branch numbers are provided, it is possible to register in association with parent information, information which did not exist at the time of starting to provide a parent message board or a parent home page but now has been completed. Accordingly, adoption of such a branch number registration system is advantageous to providers as well as searchers.

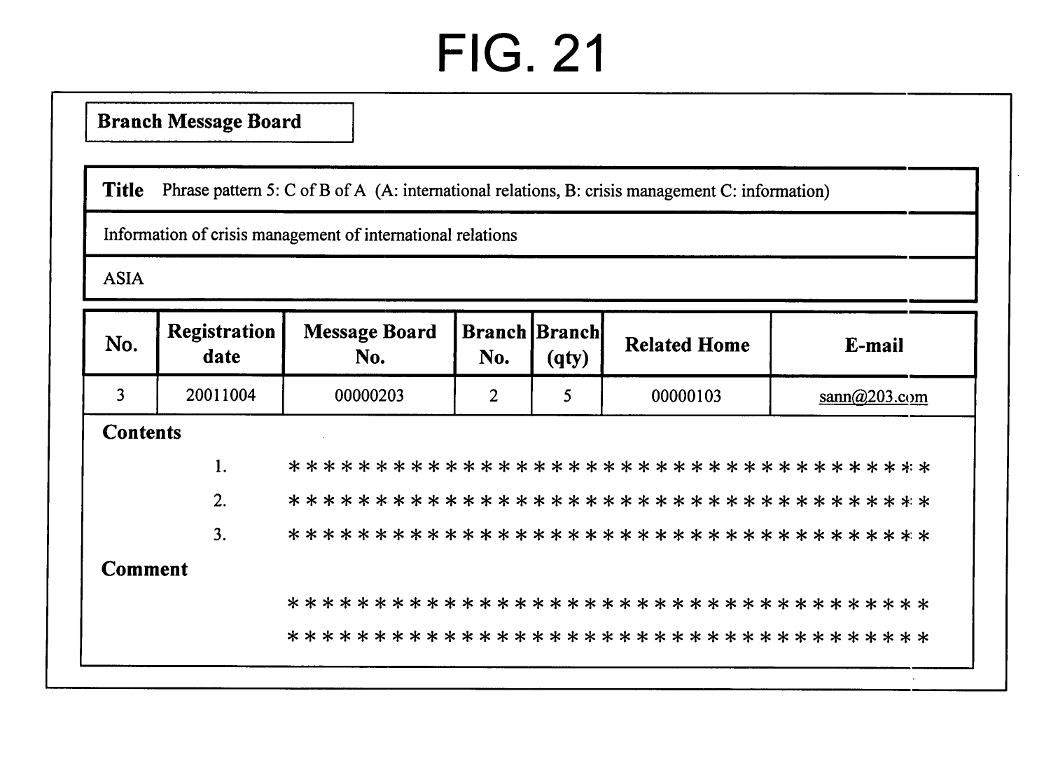

On this screen, for example, “Asia” in the screen information of FIG. 20 is clicked. Then, the page is linked to a message board of “Asia”, and information on Asia of the title phrase “information of crisis management of international relations” shown in FIG. 21 is displayed.

### SECOND EMBODIMENT

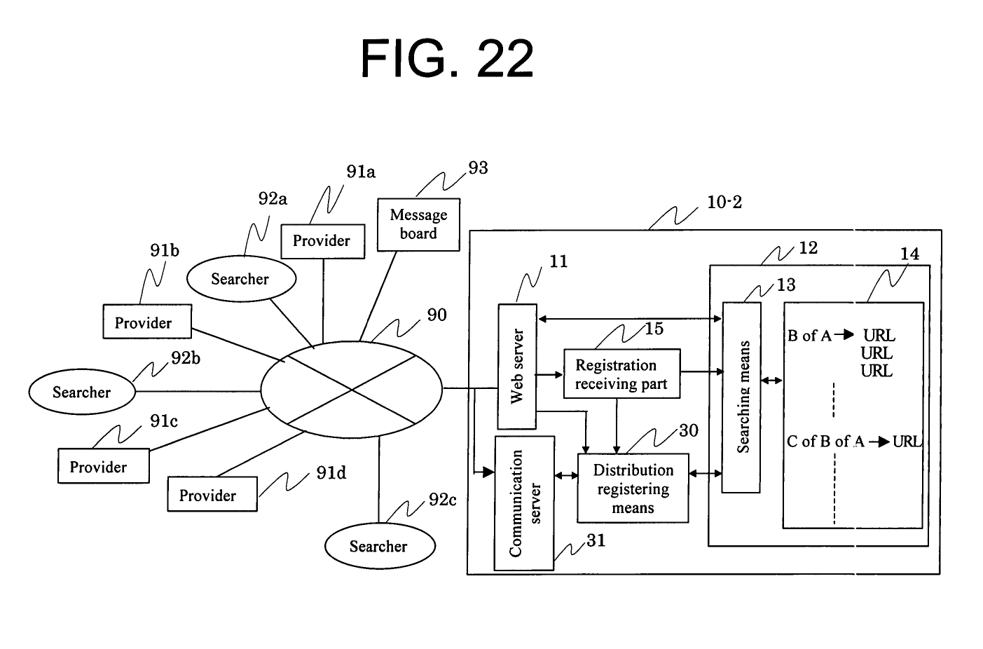

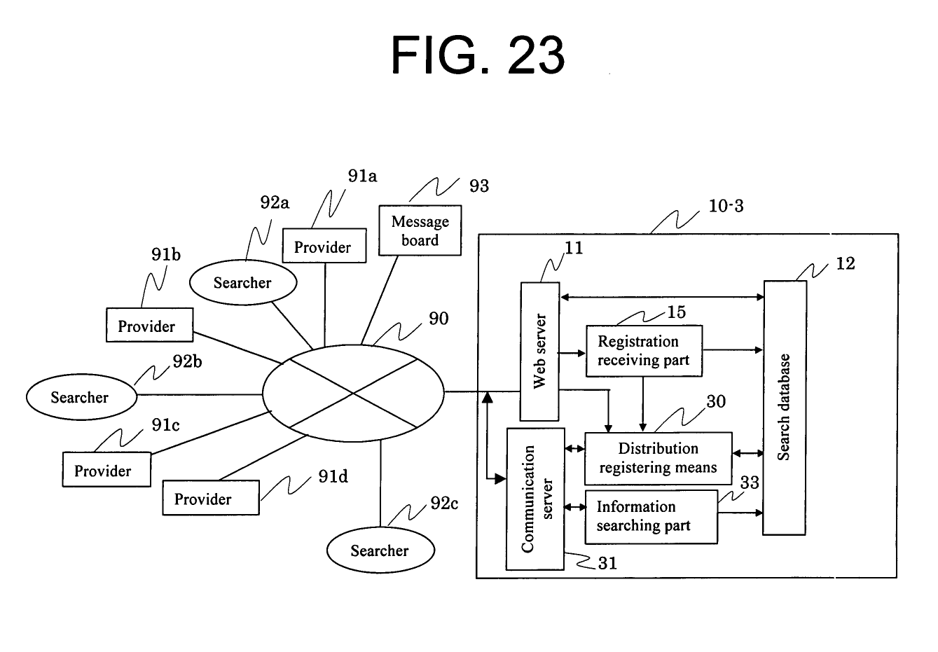

Other embodiments of the present invention are described below with reference to FIGS. 22 and 23. FIG. 22 conceptually illustrates an information search system according to a second embodiment of the present invention and its connection to a network. The system of the second embodiment is different from that of the first embodiment in that it comprises a distribution registering part 30.

According to the second embodiment, when information can not be obtained by search, search condition information of the searched information is registered at the distribution registering part 30. Then, as the searched information is registered in the database, a location of the information is conveyed to a searcher. Search condition information and a contacting method are stored in the distribution registering part 30. The distribution registering part 30 monitors information registered by the registration receiving part 15. Once pre-registered search condition information is registered, the distribution registering part 30 informs a searcher of registration of the information. For example, if e-mail address or facsimile number may be registered as a contact method, a message that searched information is newly registered is sent to a searcher by the registered e-mail address or facsimile number via a communication server (e.g., mail server).

### THIRD EMBODIMENT

FIG. 23 conceptually illustrates an information search system according to a third embodiment of the present invention and its connection to a network. The system of the third embodiment comprises an information searching part 33. The information searching part 33 regularly makes the rounds of a web site connected to the Internet 90, searches for a web site having search condition information which is in conformity to a predetermined format and when finding a corresponding web site, registers it in a database 12.

The information searching part 33 is similar to a web spider of a robot-type search engine. The information searching part 33 has a circular list therein, searches for predetermined search condition information and, when finding the information, registers it in the database 12. Listed in the circular list are information providing sites connected to the Internet and other portal sites to make rounds of, which list is renewed regularly or as necessary. HP searching means gets access to each site on the circular list and searches existence of search condition information which includes a predetermined fixed phrase pattern according to the present invention. Used as the information searching part 33 may be another general robot-type search engine.

As is clear from the above description, the present invention provides a configuration of defining search condition information by a fixed phrase pattern which consists of words connected by one or plural predetermined restricted prepositions (association words) and registering a location of desired information based on this search condition so as to search the desired information. Accordingly, it is possible to narrow information search precisely to obtain desired information. Further, according to the present invention, it is possible to register information on “what is provided” and information on “what is desired” directly in an information search system. With this configuration, a person who makes a profit by providing information or a person who want to carry out a given project or plan by collaboration is allowed to be willing to register information on “what is provided” and “what is desired” in an information search system, thereby increasing information registered in a database 12.

1. An information search system comprising:
a reception server which is connected to a network including the Internet to receive an access request from an external system connected to the network;
access data storing means for storing searchably in association with search condition information including one or a plurality of words and association information for semantically associating the words with one another, access information expressing a location of information to be searched which is specified by the search condition information;
registration processing means, connected to said reception server, for performing registration of the access information into a database under a predetermined condition, based on a registration request received via the network; and
searching means, connected to said reception server, for searching the search condition information in the database under a predetermined condition, based on a search request received via the network and outputting a search result which includes the access information corresponding to the search condition information.

2. The information search system of claim 1, wherein the access information comprises a link address to a message board or a home page.

3. The information search system of claim 2, wherein the association information comprises a short association word which indicates relation between the words, including apposition, possessive, belongingness, attribution, purpose or relation.

4. The information search system of claim 3, wherein the association word comprises: “of”, “for” and “on”.

5. The information search system of claim 3, wherein the association word corresponds to a predetermined association word in another language.

6. The information search system of claim 5, wherein said searching means carries out search by exact matching of search condition information specified by the search request and the search condition information in the database.

7. The information search system of claim 3, wherein said registration processing means comprises information storing means which is accessed based on the access information and said information string means comprises information registering means for registering information to be provided, corresponding to the search condition information.

8. The information search system of claim 7, wherein said information storing means comprises a message board.

9. The information search system of claim 8, wherein the association word corresponds to a predetermined association word in another language

10. The information search system of claim 9, wherein said searching means carries out search by exact matching of search condition information specified by the search request and the search condition information in the database.

11. An information search method comprising the steps of:
(a) receiving an access request form an external system connected to a network;
(b) in response to a request from the external system, registering in a database: search condition information including one or a plurality of words and predetermined association information for semantically associating the words with one another; and access information for accessing to public information disclosed corresponding to the search condition information so as to allow search with use of the search condition information as search key information;
(c) in response to a request from the external system, searching the database based on the search condition information specified by the external system and reading out the access information corresponding to the search condition information; and
(d) transmitting the access information read out as a search result to the external system.

12. The information search method of claim 11, wherein said step (b) further comprises the step of:
(b-1) in response to a request from the external system, registering public information disclosed corresponding to the search condition information in a predetermined disclosing medium.

13. The information search method of claim 12, wherein the access information registered in the step (b) comprises a link address to a home page or a message board.

14. The information search method of claim 13, wherein the association information comprises a short association word which indicates relation between the words, including apposition, possessive, belongingness, attribution, purpose or relation.

15. The information search method of claim 14, wherein the association word comprises: “of”, “for” and “on”.

16. The information search method of claim 13, wherein the association word corresponds to a predetermined association word in another language.

17. The information search method of claim 16, wherein searching in said step (c) is carried out by exact matching of search condition information specified by the request and the search condition information in the database.
